(19) United States
(12) Patent Application Publication
(10) Pub. No.: US 2007/0055982 A1
(43) Pub. Date: Mar. 8, 2007

(54) System and method for digital content media distribution

(75) Inventor: Michael Spilo, Greenwich, CT (US)

Correspondence Address: DARBY & DARBY P.C., P. O. BOX 5257, NEW YORK, NY, 10150-5257, US

(73) Assignee: Netgear Inc., Santa Clara, CA (US)

(21) Appl. No.: 11/514,701

(22) Filed: Aug. 31, 2006

Related U.S. Application Data
(60) Provisional application No. 60/714,122, filed on Sep. 2, 2005.

(51) Int. Cl. H04N 7/167; H04N 7/173

(52) U.S. Cl. 725/31; 725/100; 725/131

(57) ABSTRACT

Presented is a playback device capable of encrypted media content distribution that includes a processor, a decryption algorithm stored in memory, multiple units of encrypted media content preloaded on a storage device, a decoder that decrypts the media content using a decryption key, a receiver and remote control apparatus. A user obtains the decryption key from a remote system, which can be an authorization system that provides the decryption key after the user provides payment. A user account exists on the remote system, which automatically charges the user account and provides the decryption key upon receiving a media content selection and an account number or a personal identification number from the user.

### CLAIM OF PRIORITY

This application claims the benefit of priority, under 35 U.S.C. § 119(e), of U.S. Provisional Application No. 60/714,122, filed Sep. 2, 2005, and titled “System and Method for Digital Content Media Distribution,” which is hereby incorporated by reference in its entirety.

### FIELD OF THE INVENTION

A method and system for distributing movies and other audio video content on hard disk provides an alternative to pay-per-view and DVD rental or purchase.

### BACKGROUND

The distribution of media content to the home is limited to several conventional methods:

1) Broadcast Delivery—content that is accessed through a transmission medium. This category includes Over-The-Air (OTA) broadcasts using Radio Frequency (RF) transmission as well as Coax (Cable TV) or Twisted Pair (telephone) or fiber optically (telephone Co) based delivery systems, including IP based or internet delivery through the above mechanism.

2) Commercial—free access to media is provided, although interspersed with commercials. The method inherently provides content that is limited to whatever the broadcaster(s) decide to broadcast, and is further limited by the minimal availability of broadcast channels.

3) Pay Content—In this model users pay a monthly fee for access to mostly commercial-free broadcasts of TV or Music.

4) Pay-per-view—Under this approach the user pays a one time fee for access to content during a preset period (typically 24 hours), where the content is repeatedly made available by broadcast.

5) On-Demand—The user pays either a monthly fee or a one-time fee for limited access to content that is played or downloaded to the user's Set Top Box (STB).

6) Try-and-buy—This delivery method has been used primarily for computer software and allows the user to download and install (try) the software for a period of time before the software becomes inactive and requires payment. Typically the user pays and receives an unlock code which provides access to the software.

7) Free—the media content is delivered through a variety of broadcast mechanisms, including downloading over the internet.

8) Physical Delivery—the media content is delivered to consumers on some form of pre-recorded media, which the consumer can then play as needed. Invariably the user purchases a playback device separately, although on occasion the playback device can include promotional copies of pre-recorded content.

9) Unprotected analog content—such content includes printed materials, as well as analog media such as film, vinyl and plastic platters of various forms and formats, as well as various forms and formats of audio and video magnetic tape and other media.

10) Unprotected digital content—this category includes CDs, but can conventionally include paper tape, magnetic tape, and various disk technologies revolving around rigid and flexible magnetic platters.

11) Protected digital content—this content includes DVDs (content-protected by CSS). Certain content (e.g., software) has also been delivered on magnetic disks having some form of copy or access protection technology implemented to prevent re-distribution of the content.

12) Content Rental—this category of content is available for a fee allowing for time-limited use of a physically delivered media. A whole infrastructure revolving around rental of DVDs and video games has been established and currently the industry rental revenues exceed 8 $8 billion annually.

13) Bundles—Both in DVD form, and most recently in hard drive cartridges from Kaleidascape, consumers have been able to purchase a bundle of movies at one time, sometimes at a discount for the bundle.

The advantage of broadcast delivery mechanisms is two fold: (a) the price of a movie is discounted substantially from both the box-office ticket price and the physical purchase to own DVD price; and (b) the content is conveniently delivered directly to the home.

However, there are disadvantages to broadcast delivery. For instance, the selection of content is currently limited, and while on-demand libraries of Media Service Operators are growing there is still limited bandwidth available for the simultaneous delivery of a wide range of on-demand content to the home. Another disadvantage is the dislike consumers have of the pay-per-view model, and their preference of a one-time fee that covers unlimited viewing of the content.

The disadvantage of physical delivery is cost, which is exacerbated by the limited availability of warehouse space. In other words, the cost of the media, which for DVDs is approximately $2/movie, combined with the cost of the floor space needed to store a large selection at retail, makes the cost of this distribution higher. Furthermore, in order to turn the inventory, the movies must be advertised, limiting the possible distribution of older content.

Missing from the art is a mechanism that combines the convenience and cost savings of on-demand broadcast delivery with the preferred consumer experience of ownership and collection. The present invention can satisfy one or more of these and other needs.

### SUMMARY OF THE INVENTION

The present invention relates to playback device capable of encrypted media content distribution. In accordance with one aspect of the invention, the playback device comprises a processor, a decryption algorithm stored in memory, multiple units of encrypted media content preloaded on a storage device, a decoder that decrypts the media content using a decryption key, a receiver and remote control apparatus.

In accordance with another aspect of the invention, a user obtains the decryption key from a remote system, which can be an authorization system that provides the decryption key after the user provides payment.

In accordance with a further aspect of the invention, a user account exists on the remote system, which automatically charges the user account and provides the decryption key upon receiving a media content selection and an account number or a personal identification number from the user.

These and other aspects, features, steps and advantages can be further appreciated from the accompanying figures and description of certain illustrative embodiments.

### BRIEF DESCRIPTION OF THE FIGURES

FIG. 1 depicts a schematic diagram of a playback device;

FIG. 2 illustrates a direct communication diagram between a user and a system embodiment of the present invention;

FIG. 3 illustrates interactive authorization using a remote control in accordance with an embodiment of the invention; and

FIG. 4 is a flow chart of a process in accordance with an embodiment of the invention.

### DESCRIPTION OF ILLUSTRATED EMBODIMENT

By way of overview and introduction, presented and described are embodiments of a playback device that combines the convenience and cost savings of on-demand broadcast delivery with the preferred consumer experience of ownership and collection. Further, the playback device provides for better utilization of floor space at the retail distribution point and a mechanism for the possible distribution of older content

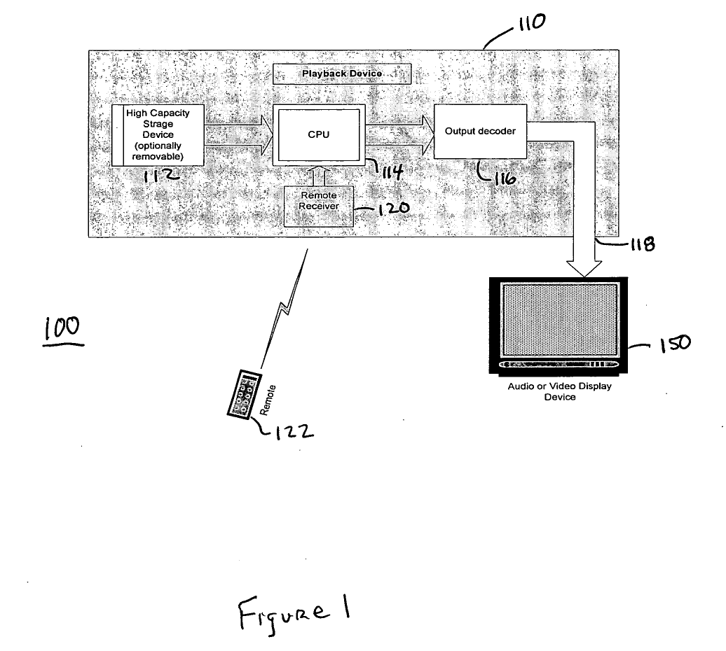

With reference to FIG. 1, one embodiment of the system 100 includes a playback device 110 comprised of a hard drive or similar high capacity storage device 112 (e.g., high capacity flash memory or high capacity optical disk), a CPU 114, a decoder 116 with video output connectors 118 and a remote control receiver 120 with an associated remote control apparatus 122. The remote control apparatus can be a handheld remote control, a keypad, a personal digital assistant, or a keyboard. The storage device 112 can be in a removable cartridge form which can be replaced with similar cartridges.

The storage device 112 is pre-loaded with encoded content, preferably in a proprietary compression encoding algorithm. Having a proprietary compression scheme makes unauthorized access to the content more difficult.

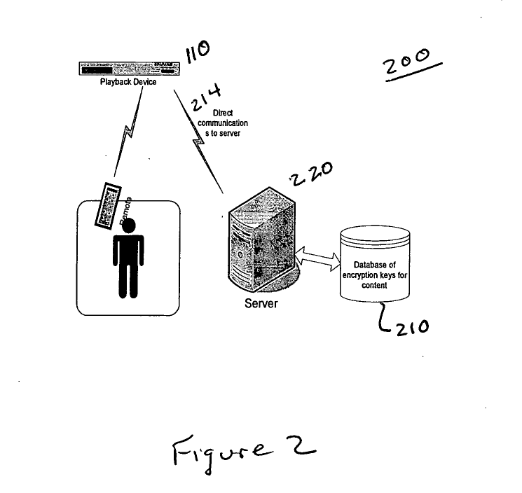

The content can be further encoded using an encryption algorithm such as triple-DES or an equivalent, as is known in the art. Each item of content can be encoded, with a separate key. The keys can be stored in a central database (FIG. 2, 210) along with identification information for the specific content and storage device 112 and/or playback device 110 on which the content is stored. The central database 210 is protectable from access by unauthorized persons.

In one embodiment the playback device storage device 112 contains about one hundred movies. Each movie is compressed and encrypted. The user purchases the complete, self contained playback device 110 which includes the content (movies) as well as the ability to play the movies, along with an unlock decryption key for the encryption.

With reference to FIG. 2, once connected to a viewing device 150, software operating instructions in the playback device 110 instructs the user to obtain an authorization code by providing an authorization system 220 with an account or electronic payment information such as a credit card number. Communication to the authorization system is made over a network communication channel 214. After the user has paid for the content, the user is provided with an decryption key, which the user enters into the playback device with the remote control apparatus 122. The playback devices uses the decryption key to decrypt the movie, and allows the user to play the movie.

In another configuration, the movie remains encrypted, and the decryption key is stored temporarily, so that the media content can be decoded for a predetermined period of time or for a predetermined number of viewings. Alternatively, the media content can be decrypted but is re-encrypted after the predetermined time period or viewings.

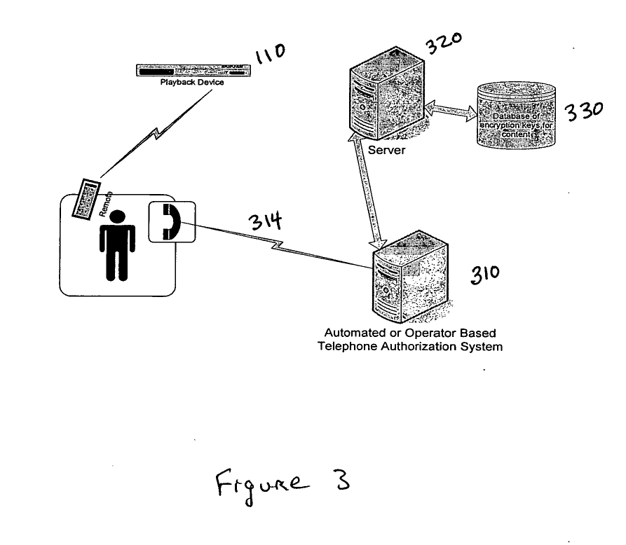

FIG. 3 depicts another embodiment of the playback device 110. This embodiment includes an electronic connection direct to the authorization/payment system through a modem connection or a network connection 314. This requires that the user connect the device to a phone line or network, but then authorization could be automated.

The system can optionally have parental locking, require passwords for new purchases and limiting viewable content by MPAA or similar rating system.

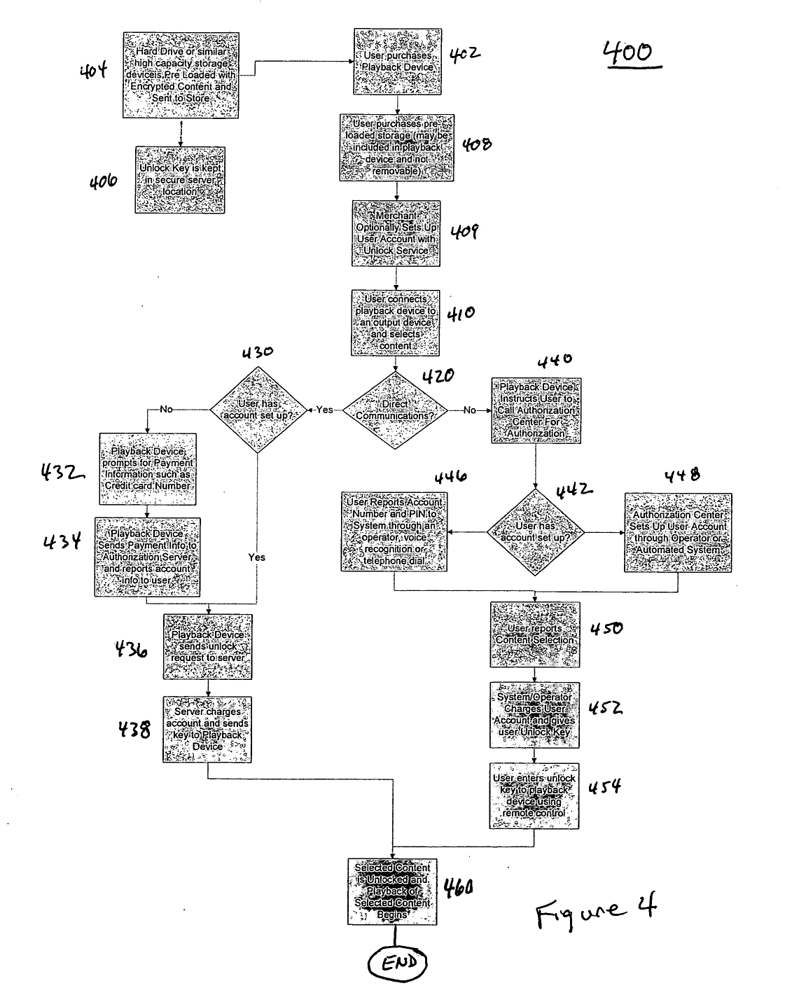

FIG. 4 is a flow chart of process 400 in accordance with an embodiment of the invention. A storage device 112, such as a hard drive or other high capacity device is pre-loaded with encrypted media content and provided to a channel of distribution, for instance a store 404. An unlock decryption key is associated with the encrypted media content and located in a secure location 406. A user purchases, step 402, the playback device 110. In one embodiment, the storage device 112 is included in device 110, or alternatively is removable and available separately 408. At step 409, an optional user account is created for the user to provide unlock service. To view content, the user connects, step 410, the playback device 110 to a output display device 150.

To decrypt the content, two embodiments of the present invention are described. In the first embodiment either the user already has the decryption key, or contacts an authorization center 220 for the decryption key. In the second embodiment, the playback device makes contact with the authorization system through an automated and/or telephone operator based authorization system 310. At step 420, a decision is made as to whether there is direct communication by the playback device or the user.

If the user is to contact the authorization system the process 400 continues to step 440, where the playback device 110 prompts the user to contact the authorization system. If the user already has an account, step 442, the user provides the account information—e.g., personal identification number or code, or password, etc. To setup an account, the authorization system proceeds, step 448, either automatically with prompts or to an operator for interactive human assistance.

The user selects, step 450, the desired media content. The authorization system charges the user account, step 452, and provides the unlock decryption key to the user. At step 454, the user enters the decryption key into the remote control apparatus 122, which communicates the decryption key to the remote control receiver 120. The decoder 116 decodes the encrypted media content and playback of the media content begins on the display device 150 connected to the video output connectors 118.

If the playback device is to contact the authorization system the process 400 continues to step 430. If there is not an existing user account, the playback device prompts, step 432, the user to provide payment information. This information can be provided by the user via the remote control apparatus 122. The playback device creates a communication path 214 with the authorization system 220 at step 434. For existing accounts, or after an account is setup, the playback device, step 436 sends a request for an unlock decryption key to the authorization system. The authorization system, step 438, charges the user account and returns the decryption key to the playback device 110. Whereupon, the process continues at step 460 and playback begins.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

I claim:

1. A playback device for media distribution comprising:
a processor;
memory that contains operating instructions configured as a decryption algorithm;
a storage device pre-loaded with multiple units of media content, wherein each unit of media content is encrypted using an encryption algorithm;
a decoder configured to access the media content in the storage device under control of the processor, and decrypt the media content in accordance with the operating instructions;
a receiver in communication with the processor; and
a remote control apparatus, in data communication with the receiver, configured to interface with a user to provide control signals to the playback device;
wherein the decryption algorithm accesses the encrypted media content using a decryption key.

2. The playback device of claim 1, wherein the storage device is removable from the playback device.

3. The playback device of claim 1, wherein the storage device is separate from the playback device.

4. The playback device of claim 1, wherein the remote control apparatus is one of a handheld remote control, a keypad, a personal digital assistant, and a keyboard.

5. The playback device of claim 1, wherein the decryption key is provided to the playback device by a user-entry in the remote control apparatus.

6. The playback device of claim 1, further comprising a network connection, wherein the decryption key is provided to the playback device via the network connection.

7. The playback device of claim 5, wherein the user obtains the decryption key from a remote system.

8. The playback device of claim 7, wherein the remote system is an authorization system, and wherein the user obtains the decryption key after the user provides payment information to the remote system using the remote control apparatus.

9. The playback device of claim 1, wherein the user provides the playback device with media content selection and playback commands via the remote control apparatus.

10. The playback device of claim 5, wherein the user provides the playback device with media content selection and playback commands via the remote control apparatus, wherein the decryption key for only the selected media content is provided, and wherein a remote system charges for the selected media content.

11. The playback device of claim 5, wherein the decryption key expires after a predetermined time period or a predetermined number of viewings.

12. The playback device of claim 7, wherein the user obtains a fixed number of decryption keys, and wherein the fixed number is renewable upon payment of a fee.

13. The playback device of claim 7, wherein a user account exists on the remote system, and wherein the remote system is configured to automatically charge the user account and provide the decryption key upon receiving identification of a selected media content and at least one of an account number and a personal identification number.

14. The playback device of claim 1, wherein the storage device is one of a disk drive, a flash memory, and an optical disk.

15. The playback device of claim 1, wherein the media content is one of movies, television shows, and prerecorded audio.
